(19) United States
(12) Patent Application Publication
(10) Pub. No.: US 2025/0243995 A1
(43) Pub. Date: Jul. 31, 2025

(54) LIGHT SOURCE FOR INSTALLATION IN A LUMINAIRE AND LUMINAIRE WITH THE LIGHT SOURCE

(71) Applicant: LEDVANCE GmbH, Garching bei München (DE)

(72) Inventors: Zhian LI, Shenzhen Guangdong (CN); Jürgen OSER, München (DE); Armin KONRAD, Großaitingen (DE); Henrike STREPPEL, Regensburg (DE); Shaoping CHEN, Shenzhen Guangdong (CN)

(21) Appl. No.: 19/036,135

(22) Filed: Jan. 24, 2025

(30) Foreign Application Priority Data
Jan. 29, 2024 (CN) 202410120542.6

(51) Int. Cl. F21V 19/00; F21Y 103/10; F21Y 115/10

(52) U.S. Cl. CPC F21V 19/0045; F21V 19/0055; F21Y 2103/10; F21Y 2115/10

(57) ABSTRACT

A light source configured for installation in a luminaire is provided. The light source includes at least one mounting base configured for placement on at least one mounting platform of the luminaire, such that by sliding the at least one mounting base of the light source on the at least one mounting platform of the luminaire, the at least one mounting base is configured to be brought into a position where at least one fixing element of the luminaire at least partially overlaps with the at least one mounting base of the light source, whereby the light source is fixed to the luminaire by the at least one fixing element of the luminaire. Furthermore, a luminaire with the light source is provided.

### CROSS-REFERENCE TO RELATED APPLICATIONS

This patent application claims the benefit of and priority to Chinese Patent Application No. 202410120542.6, filed on Jan. 29, 2024, which is herein incorporated by reference in its entirety.

### FIELD OF THE DISCLOSURE

The present application generally relates to light sources. Specifically, the present disclosure relates to a light source configured for installation in a luminaire and a luminaire with the light source.

### BACKGROUND

In view of environmental challenges such as shortages of raw materials and resources, the compatibility of luminaires with a circular economy is becoming increasingly important. For example, in cases of luminaire upgrades or repairs, end users and/or installers are encouraged to replace parts or components of the luminaire rather than the entire luminaire. However, replacing certain parts of a luminaire may require tools and technical expertise that end users may not possess. In the case of luminaires with light-emitting diode (LED) light sources, replacing the light source without damaging the LED light source or light engine can be a challenging task.

### SUMMARY

An object of the present application is to provide a particularly simple and reliable way to replace light sources in luminaires.

According to a first aspect, a light source configured for installation in a luminaire is provided. The light source includes at least one mounting base configured for placement on at least one mounting platform of the luminaire. Specifically, the at least one mounting base may include a substantially flat contact surface for contacting a substantially flat contact surface of the at least one mounting platform of the luminaire.

The at least one mounting base is configured such that by sliding the mounting base of the light source on the at least one mounting platform of the luminaire, the at least one mounting base is configured to be brought into a position where at least one fixing element of the luminaire at least partially overlaps with the at least one mounting base of the light source. Specifically, the sliding or movement of the at least one mounting base is configured to be performed in a lateral direction (i.e., parallel to the contact plane of the at least one mounting base and the at least one mounting platform). Thereby, the light source is fixed to the luminaire by the at least one fixing element of the luminaire. Specifically, due to the overlap between the at least one fixing element and the at least one mounting base of the light source, the at least one mounting base is configured to be at least partially covered by the at least one fixing element of the luminaire, thus preventing separation of the light source from the luminaire. To remove the light source from the luminaire, the light source is configured to be moved back to a position where the mounting base is not covered by the at least one fixing element, such that the mounting base of the light source is configured to be easily separated from the mounting platform of the luminaire.

Thus, the light source can be easily installed in the luminaire in two steps (i.e., placing and moving the mounting base). Consequently, the light source can be easily removed from the luminaire in the same two steps in reverse order, namely by moving and removing the mounting base from the mounting platform of the luminaire.

The mounting base may comprise at least one channel or through-hole for the at least one fixing element of the luminaire, enabling placement of the at least one mounting base on the at least one mounting platform of the luminaire. Specifically, the at least one channel of the at least one mounting base may be configured such that when the at least one mounting base is placed on the mounting platform of the luminaire, the at least one fixing element of the luminaire does not obstruct the path of the mounting base.

The light source may be configured as a linear light source, wherein the at least one mounting base is configured for fixing the light source by a plurality of fixing elements distributed along at least one longitudinal edge of the light source. Specifically, the plurality of fixing elements may be arranged in at least one row along at least one longitudinal edge of the light source. Particularly in the case of long light sources such as linear light sources, a plurality of fixing elements arranged along at least one longitudinal edge of the light source can ensure reliable fixing of the light source in the luminaire along its entire length.

The at least one mounting base may comprise at least one recess on at least one longitudinal edge of the at least one mounting base. Specifically, the at least one recess may be configured to accommodate the at least one fixing element of the luminaire, enabling easy placement of the at least one mounting base on the at least one mounting platform of the luminaire.

The light source may comprise at least one printed circuit board (PCB), wherein the at least one mounting base is formed by the at least one printed circuit board of the light source. Thus, the at least one PCB of the light source or light engine can be used both for mounting electrical components of the light source and for mounting the light source in the luminaire without any additional mounting devices.

In some embodiments, the light source comprises a holding element, particularly for stabilizing the shape of the light source, wherein the at least one mounting base is formed by the at least one holding element. Thus, the holding element can combine the functions of a stabilizing element and a mounting element, making the light source particularly stable and easy to install.

Specifically, the holding element may be configured as a holding profile for holding the printed circuit board of the light source. Particularly in the case of linear light sources with elongated printed circuit boards, the holding profile can provide reliable support for stabilizing the shape of the printed circuit board.

According to a second aspect, a luminaire with at least one light source according to the first aspect is provided. The luminaire includes at least one fixing element for fixing the light source and at least one mounting platform for placing the mounting base of the light source, such that by sliding the at least one mounting base on the at least one mounting platform of the luminaire, the at least one mounting base is configured to be brought into a position where the at least one fixing element of the luminaire at least partially overlaps with the at least one mounting base of the light source, whereby the light source is fixed to the luminaire by the at least one fixing element of the luminaire. Through the above two-step installation or removal process, the light source can be easily and reliably installed in the luminaire or easily and reliably replaced in the luminaire.

The luminaire may be configured to receive a linear light source, wherein the at least one fixing element comprises a plurality of fixing elements for fixing the light source along at least one longitudinal edge of the light source. Due to the plurality of fixing elements distributed along the longitudinal edge of the light source, the light source reliably fixed along its entire length in the luminaire is reliably secured.

The luminaire may comprise a stop member for limiting the sliding path of the at least one mounting base of the light source. With the aid of the stop member or restrictor, the mounting base can be automatically stopped in the correct position during installation of the light source.

### BRIEF DESCRIPTION OF THE DRAWINGS

In the following description, details are provided to describe embodiments of the specification. However, it will be apparent to those skilled in the art that these embodiments may be implemented without these details.

Some components of the embodiments have similar parts. Similar parts may have the same name or similar reference numerals. Where appropriate, description of one part applies with reference to another similar part, thereby reducing repetition of text without limiting the present disclosure.

FIG. 1 shows a partial perspective view of a luminaire according to an embodiment,

FIG. 2 shows a partial perspective view of a light source according to an embodiment,

FIG. 3 shows a partial perspective view of a luminaire with the light source according to FIG. 2 in a first position,

FIG. 4 shows a partial perspective view of the luminaire of FIG. 3 with the light source in a second position,

FIG. 5 shows a top view of the luminaire according to FIG. 3 and FIG. 4 with the light source in two different positions,

FIG. 6 shows a partial perspective view of a light source according to a second embodiment,

FIG. 7 illustrates the installation process of the light source according to the embodiment of FIG. 6,

FIG. 8 shows a detailed perspective view of a light source and luminaire according to a further embodiment,

FIG. 9 shows a perspective view of a luminaire with a light source according to another embodiment,

FIG. 10 shows a first partial view of a luminaire with a light source according to an embodiment,

FIG. 11 shows a second partial view of the luminaire according to FIG. 10,

FIG. 12 shows a partial view of a luminaire according to an embodiment, and

FIG. 13 shows a partial view of a luminaire according to an embodiment.

### DETAILED DESCRIPTION

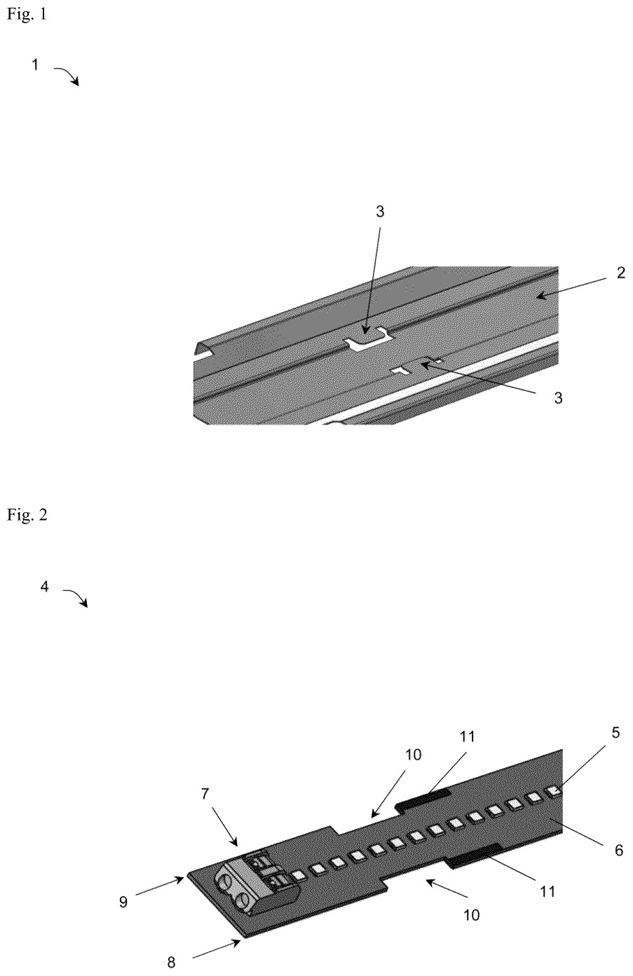

FIG. 1 shows a partial perspective view of a luminaire 12 according to an embodiment. Specifically, FIG. 1 shows a mounting structure 1 of a luminaire housing 13 configured to accommodate a light source 4.

In the shown embodiment, the luminaire 12 is configured as a linear lamp having an elongated luminaire body. For purposes of clarity, only a portion of the mounting structure 1 of the luminaire housing 13 is shown in FIG. 1.

The mounting structure 1 includes a substantially profile-shaped elongated body configured to accommodate an elongated light source 4 or linear light source 4. Specifically, the mounting structure 1 includes a mounting platform 2 for mounting the mounting base of the light source 4. The mounting structure 1 also includes fixing elements 3 for fixing the mounting base of the light source 4 to the mounting platform 2 of the mounting structure 1 of the luminaire housing 13.

FIG. 2 shows a partial perspective view of a light source 4 according to an embodiment. In this embodiment, the light source 4 is configured as a light-emitting diode (LED) light source with a plurality of LEDs 5 mounted on a printed circuit board (PCB) 6. The light source 4 also includes a connector 7 mounted on the PCB 6 for electrically connecting the PCB 6 to a power supply.

The PCB 6 has an elongated, substantially rectangular shape with a first longitudinal edge 8 and a second longitudinal edge 9 opposite to the first longitudinal edge 8.

The PCB 6 includes a plurality of recesses 10 and a plurality of mounting areas 11 arranged on the first longitudinal edge 8 and the second longitudinal edge 9 of the PCB 6. In this embodiment, the mounting areas 11 are configured as contact pads of the PCB 6. In some embodiments, the surface of the mounting areas 11 is the same as the surface of the remainder of the PCB 6 without electrical contacts or contact pads.

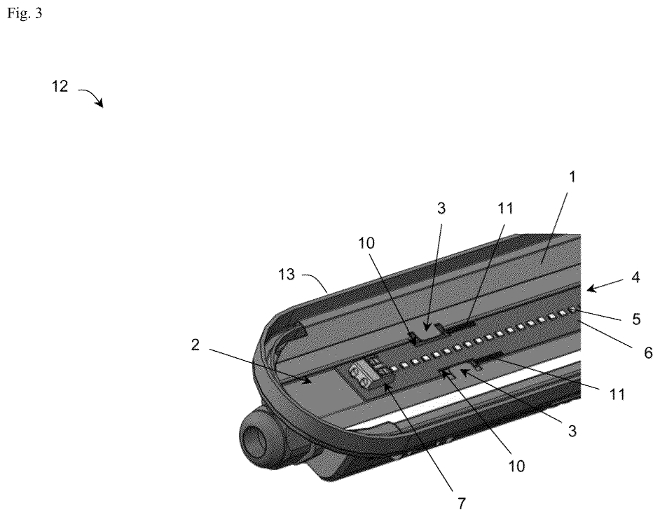

FIG. 3 shows a partial perspective view of a luminaire 12 with the light source 4 according to the embodiment of FIG. 2 in a first position. The luminaire 12 includes a luminaire housing 13 in which the mounting structure 1 according to FIG. 1 is arranged. In this embodiment, the luminaire 12 is configured as a linear lamp for ceiling mounting. In the position shown in FIG. 3, the light source 4 is arranged on the mounting platform 2 in a first position (or pre-fixed position). In this position of the light source 4 relative to the luminaire housing 13, the fixing elements 3 of the mounting structure 1 are located in the recesses 10, and the mounting areas 11 are not covered by the fixing elements 3. Thus, because the fixing elements 3 do not hold the light source 4, the light source 4 is released.

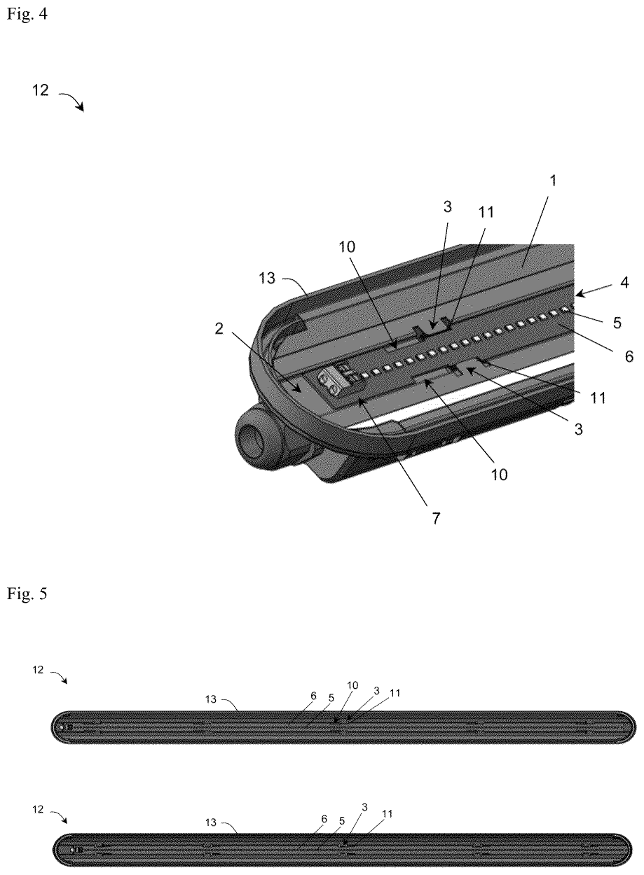

FIG. 4 shows a partial perspective view of the luminaire 12 of FIG. 3 with the light source 4 in a second position. In the second position (or fixed position), the light source 4 is positioned such that the fixing elements 3 of the mounting structure 1 are positioned over the mounting areas 11 of the PCB 6.

Compared to the first (or pre-fixed) position shown in FIG. 3, the light source 4 has been moved to the left relative to the luminaire housing 13 so that the fixing elements 3 can press onto the mounting areas 11 and can hold the PCB 6 of the light source 4 in that position. Thus, the PCB 6 serves as the mounting base of the light source 4, which is mounted on the mounting platform 2 of the luminaire 12 and fixed by the fixing elements 3.

FIG. 5 shows a top view of the luminaire 12 according to FIGS. 3 and 4 with the light source 4 in two different positions. In FIG. 5, the luminaire 12 is shown in its entire length. In this embodiment, the luminaire 12 includes five fixing elements 3 on each of the longitudinal edges 8 and 9 of the light source 4. The light source 4 includes five recesses 10 and five mounting areas 11 on each of the longitudinal edges 8 and 9 of the PCB 6.

In the upper portion of FIG. 5, the light source 4 is shown in the second (or fixed) position, where the fixing elements 3 are positioned on top of the mounting areas 11. In the lower half of FIG. 5, the light source 4 is shown in the first (or pre-fixed) position. In this position, the fixing elements 3 are located at the longitudinal position of the recesses 10. Thus, the PCB 6 or mounting base of the light source 4 is not covered by the fixing elements 3. Consequently, in the pre-fixed position, which also can be referred to as the post-fixed position, the PCB 6 or mounting base of the light source 4 is not fixed to the mounting platform 2 of the luminaire 12. Therefore, from the pre-fixed position or post-fixed position, the light source 4 can be freely removed from the mounting platform 2, for example, for replacement or fixed by simply moving it slightly in the longitudinal direction. The movement distance of the light source 4 for fixing and/or dismounting can be as short as a few millimeters or centimeters, thereby enabling the installation and replacement of the light source 4 to be particularly convenient for users or installers.

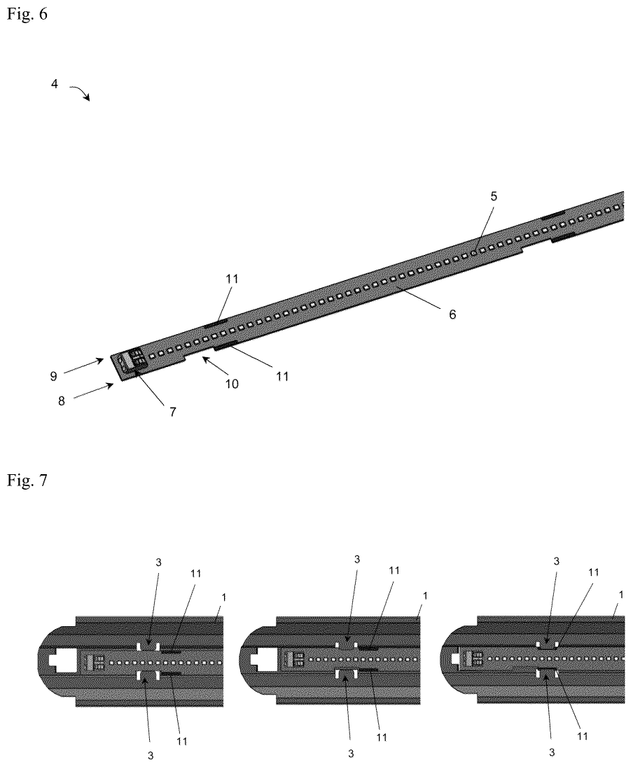

FIG. 6 shows a partial perspective view of a light source 4 according to a second embodiment. Similar to the embodiment of FIG. 3, the embodiment of FIG. 6 includes a plurality of LEDs 5 arranged in rows on a substantially rectangular elongated PCB 6. The light source 4 of FIG. 6 also includes a plurality of recesses 10 and mounting areas 11. However, compared to the embodiment of FIG. 2, the recesses 10 are provided only on one longitudinal edge 8 or 9 of the PCB 6, while the mounting areas 11 are provided on both longitudinal edges 8 and 9 of the PCB 6.

FIG. 7 illustrates the installation process of the light source 4 according to the embodiment of FIG. 6. Similar to the installation process of the light source 4 of FIG. 2, the light source 4 is first placed with the mounting base or PCB 6 on the mounting platform 2 of the luminaire 12 and then moved to the fixed position where the fixing elements 3 are positioned on top of the mounting pads of the PCB 6, thereby fixing the light source 4 in the luminaire 12.

FIG. 7 shows the light source 4 in three different positions on the mounting structure 1 of the luminaire 12. In the first (or pre-fixed) position (left side in the figure), the light source 4 is positioned on the mounting platform 2, similar to the pre-fixed position discussed above in connection with FIG. 5.

In the second (or semi-fixed) position, the light source 4 is moved laterally (upward in the figure) such that the mounting base or PCB 6 is partially covered by the fixing elements 3 on one side.

In the third or fixed position, similar to the fixed position in the embodiment of FIG. 5, the PCB 6 is fixed by the fixing elements 3 on both longitudinal edges 8 and 9 or mounting bases.

Thus, in the embodiment of FIG. 7, the light source 4 can be installed in a three-step process comprising placing the mounting base or PCB 6 on the mounting platform 2 of the luminaire 12, moving the mounting base laterally to engage one longitudinal edge 8 or 9 of the mounting base with the fixing elements 3, and moving the mounting base in the longitudinal direction such that both longitudinal edges 8 and 9 of the mounting base engage with or are fixed by the fixing elements 3. Compared to the embodiment of FIG. 2, this embodiment of the light source 4 includes fewer recesses 10 in the PCB 6. Thus, the light source 4 is not only easy to install but also more stable.

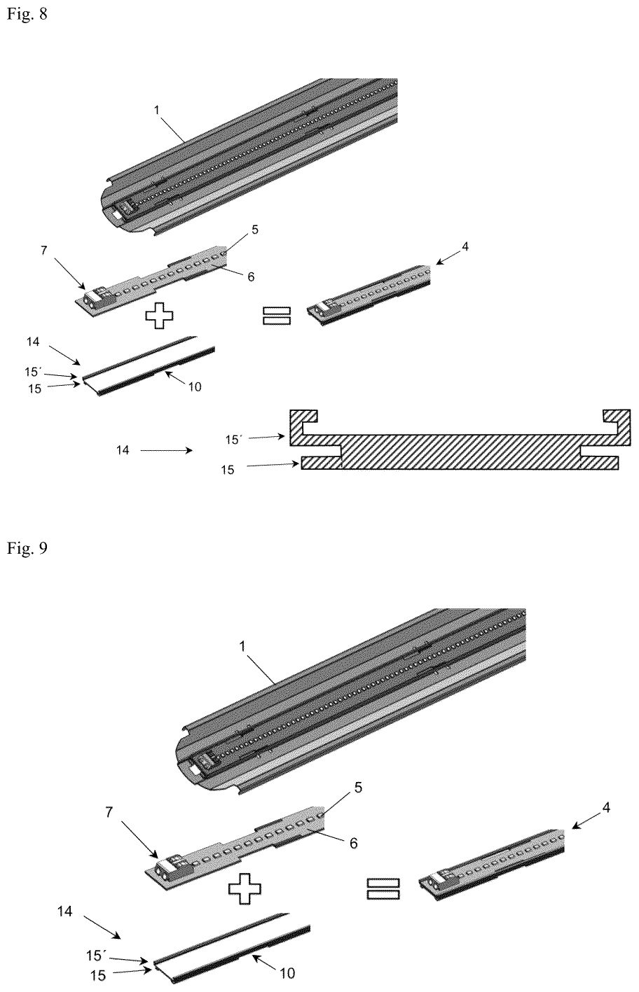

FIG. 8 shows a detailed perspective view of a light source 4 and a luminaire 12 according to a further embodiment. In the embodiment of FIG. 8, the light source 4 includes a PCB 6 with LEDs 5 and a connector 7 mounted thereon, and a holding element 14, similar to the embodiment of FIG. 2. In this embodiment, the holding element 14 is an aluminum profile configured to accommodate the PCB 6 and mount the light source 4 on the mounting platform 2 of the luminaire 12. Specifically, the aluminum profile optionally can be added to retrofit the light source 4, for example, as a light source spare part.

For greater clarity, the lower right portion of FIG. 8 shows an enlarged schematic cross-section of the holding element 14. The holding element 14 includes a bottom portion 15 for mounting the light source 4 in the luminaire 12 and a top portion 15′ for accommodating the PCB 6 of the light engine. Specifically, the bottom portion 15 of the holding element 14 includes recesses 10, similar to the recesses 10 in the PCB 6 of the embodiments of FIG. 2 or FIG. 6. Thus, the bottom portion 15 of the holding element 14 can serve as the mounting base for mounting the light source 4 in the luminaire 12, such that the bottom portion 15 is held by the fixing elements 3 of the luminaire 12. This embodiment of the light source 4 can be easily installed in the luminaire 12 in a two-step installation process, similar to the embodiment of FIG. 2. Due to the holding element 14, the light source 4 is particularly stable since the holding element 14 stabilizes the shape of the PCB 6, as the flexibility of the PCB 6 could make the replacement process difficult. The aluminum profile can be configured such that the light source 4 with the aluminum profile as the holding element 14 still has some flexibility for easy replacement but is sufficiently rigid for easier handling.

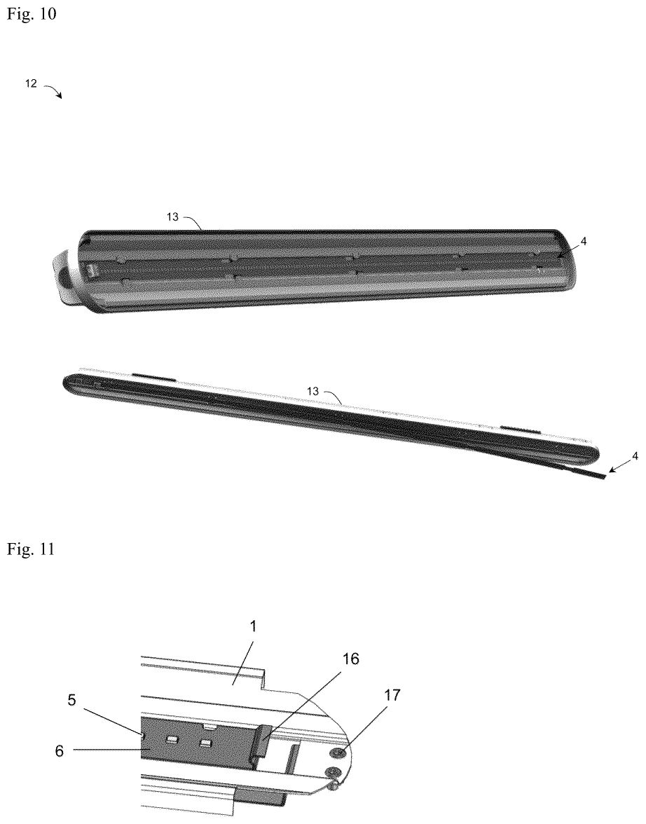

FIG. 9 shows a perspective view of a luminaire 12 with a light source 4 according to another embodiment. The luminaire 12 of FIG. 9 substantially corresponds to the embodiment of FIG. 5, with the difference that some recesses 10 or cutouts are omitted in the PCB 6 of the light source 4. In some embodiments, there are no cutouts at the position of the last one or last two fixing elements 3. Thus, in these embodiments, the light source 4 cannot be installed in the same way as the light sources 4 according to the embodiments of FIGS. 2 and 6. Instead, to install the light source 4, the longitudinal end of the PCB 6 is first placed on the mounting platform 2 and pushed under the fixing elements 3 near the end of the luminaire 12. Thus, the light source 4 can be brought into an intermediate position, such as the position shown in the lower portion of FIG. 9. In this intermediate position or partially fixed position, one end of the light source 4 is held by the fixing elements 3, thereby facilitating for an installer to handle the light source 4 during installation. Thereafter, by moving the light source 4 longitudinally along the luminaire 12 body, the light source 4 can be brought to the pre-fixed position and from the pre-fixed position to the fixed position (upper portion of FIG. 9). Thus, the light source 4 can be easily and firmly installed in the luminaire 12. Due to one end of the light source 4 being fixed to the partially fixed position of the mounting platform 2 of the luminaire 12, the installation process can be further simplified. Especially when replacing light sources 4 in overhead-mounted luminaires 12, it can be difficult to correctly hold the light source 4 spare part with both hands to simultaneously insert all fixing positions. The embodiment of FIG. 10 represents a solution to this problem. First, the end without cutouts is inserted into the luminaire 12. Then, this end no longer needs to be held by hand, and the remaining part of the PCB 6 can be inserted into the holding structure with the fixing elements 3 by hand.

FIG. 11 shows a first partial view of a luminaire 12 with a light source 4 according to an embodiment. In this embodiment of the luminaire 12, the luminaire 12 includes a stop member 16 for longitudinal positioning of the PCB 6.

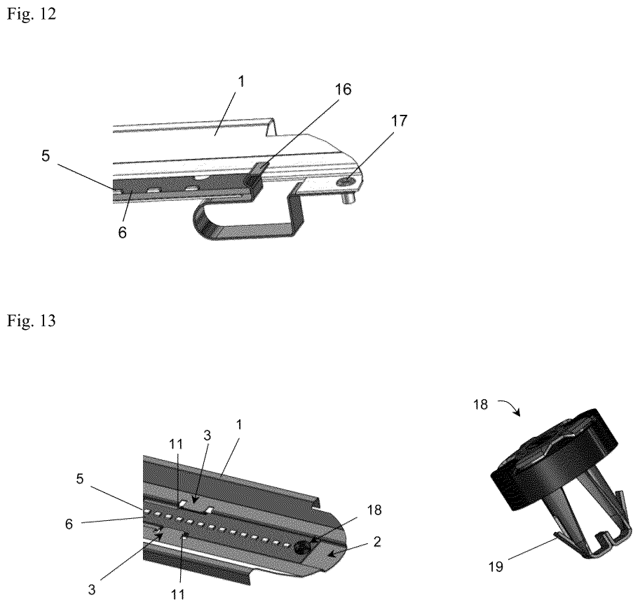

FIG. 12 shows a second partial view of the luminaire 12 according to FIG. 11. Specifically, FIG. 12 shows a partial sectional view in a perspective view of the embodiment of FIG. 11. In the sectional view, the shape of the stop member 16 can be seen. The stop member 16 is formed as a spring clip or elastic band comprising a first end fixed to the mounting structure 1 by fixing elements (particularly rivets 17 or screws) and a second end configured to accommodate the longitudinal end of the PCB 6. Due to the stop member 16, the PCB 6 or light source 4 can be mechanically stabilized in its fixed position.

FIG. 13 shows a partial view of a luminaire 12 according to an embodiment. In the embodiment of FIG. 13, the luminaire 12 includes a PCB fixing pin 18 for additional stabilization of the PCB 6. An enlarged view of the fixing pin 18 is shown on the right side of FIG. 13. The PCB fixing pin 18 has barbs 19 for connecting the fixing pin 18 to the PCB 6, thus preventing the fixing pin 18 from falling out before or during the installation process.

As shown by the above description of embodiments of the light source 4 and luminaire 12, the light source 4 can be easily installed and/or replaced without needing to move the light source 4 over longer travel distances. Specifically, bringing the light source 4 from partial fixed, pre-fixed, semi-fixed positions into the fixed position, and vice versa, does not require extensive movement of the light source 4 compared to its longitudinal dimension. Furthermore, reliable fixing of the light source 4 in the luminaire 12 is achieved due to the bilateral fixing by the fixing elements 3 and due to the optional stop member 16. In some embodiments, the mounting pads are configured as ground contacts for electrical connection of the PCB 6 or the light source 4 via the fixing elements 3 of the conductive mounting structure 1 of the luminaire 12, thus improving safety.

For linear lamps with long light sources 4 or PCBs 6, the above system allows particularly easy and firm installation of the light source 4 in ceiling-mounted luminaires 12, particularly due to the short travel path of the light source 4 for bringing the light source 4 into different fixed positions. Furthermore, the above light source 4 embodiments are characterized by simple structure and low bill of materials. No additional fixing elements or tools that could be easily lost during installation or replacement of the light source 4 are needed for mounting and fixing the light source 4.

Due to the short travel distance for inserting or removing the light source 4, less space is needed for performing the light source 4 installation or replacement. Furthermore, because the overall positive effect is achieved through minor modifications to the light source 4, the light source 4 can still comply with relevant standards, for example, standards of the Zhaga Consortium.

While at least one exemplary embodiment has been presented in the above detailed description, it should be understood that there are numerous variations. It should also be understood that one or more exemplary embodiments are only examples and are not intended to limit the scope, applicability, or configuration of the present disclosure in any way. Rather, the above detailed description will provide those skilled in the art with a convenient roadmap for implementing one or more exemplary embodiments.

### LIST OF REFERENCE SYMBOLS

1 Mounting structure
2 Mounting platform
3 Fixing element
4 Light source
5 LED
6 PCB
7 Connector
8 First longitudinal edge
9 Second longitudinal edge
10 Channel or recess
11 Mounting area
12 Luminaire
13 Housing
14 Holding element
15 Bottom portion
15′ Top portion
16 Stop member
17 Rivet
18 Fixing pin
19 Barb

What is claimed is:

1. A light source configured for installation in a luminaire, the light source comprising at least one mounting base configured for placement on at least one mounting platform of the luminaire, wherein, by sliding the at least one mounting base of the light source on the at least one mounting platform of the luminaire, the at least one mounting base is brought into a position where at least one fixing element of the luminaire at least partially overlaps with the at least one mounting base of the light source, whereby the light source is fixed to the luminaire by the at least one fixing element.

2. The light source according to claim 1, wherein the at least one mounting base comprises at least one channel for the at least one fixing element of the luminaire, thereby enabling placement of the at least one mounting base on the at least one mounting platform of the luminaire.

3. The light source according to claim 1, wherein:
the light source is configured as a linear light source; and
the at least one mounting base is configured to fix the light source by a plurality of fixing elements distributed along at least one longitudinal edge of the light source.

4. The light source according to claim 3, wherein the at least one mounting base comprises at least one recess on at least one longitudinal edge of the at least one mounting base.

5. The light source according to claim 1, further comprising at least one printed circuit board, wherein the at least one mounting base is formed by the at least one printed circuit board.

6. The light source according to claim 1, further comprising at least one holding element, wherein the at least one mounting base is formed by the at least one holding element.

7. The light source according to claim 6, wherein the at least one holding element is configured as a holding profile for holding a printed circuit board of the light source.

8. A luminaire configured to receive the light source according to claim 1, the luminaire comprising:
the at least one fixing element; and
the at least one mounting platform.

9. The luminaire according to claim 8, wherein:
the light source is configured as a linear light source; and
the at least one fixing element comprises a plurality of fixing elements distributed along at least one longitudinal edge of the light source.

10. The luminaire according to claim 8, wherein the luminaire further comprises a stop member configured for limiting a sliding path of the at least one mounting base of the light source.
